(19) United States
(12) Patent Application Publication
(10) Pub. No.: US 2018/0338019 A1
(43) Pub. Date: Nov. 22, 2018

(54) MESSAGE BROKER SYSTEM

(71) Applicant: Bsquare Corp., Bellevue, WA (US)

(72) Inventor: David Wagstaff, Lake Forest, CA (US)

(21) Appl. No.: 15/984,191

(22) Filed: May 18, 2018

Related U.S. Application Data
(60) Provisional application No. 62/508,152, filed on May 18, 2017.

(51) Int. Cl. H04L 29/06; H04L 29/08

(52) U.S. Cl. CPC H04L 69/08; H04L 67/2809; H04L 69/02

(57) ABSTRACT

A method including receiving raw data; transforming the raw data into transformed data; enriching the transformed data into enriched data; and sending the enriched data to one or more machines to affect a machine state of the one or more machines. A computing apparatus includes a processor and memory that stores instructions to configure the apparatus to detect raw data being transmitted to a message broker from a plurality of edge devices; retrieve processing instructions from a non-volatile memory structure, transmit the processing instructions to the message broker; receive the processing instructions with the message broker, and apply the protocol adapter instructions to a protocol adapter to wrap the raw data in a raw observation. The raw data is transformed into transformed data; enriched into enriched data; and sent to one or more machines to affect a machine state of the one or more machines.

### CROSS REFERENCE TO RELATED APPLICATIONS

This application claims the benefit of U.S. provisional patent application Ser. No. 62/508,152, filed on May 18, 2017, the contents of which are incorporated by reference herein in their entirety.

### BACKGROUND

In many cases an embedded system is deployed in the field and forgotten. Meanwhile, technology evolves and changes around the deployed system. Older deployed systems have serial interfaces to gain access to the device and information it contains. As the internet has become prevalent, users wish to access their devices without having to go personally to the device and plug in a computer to download data. Consequently, a demand arose to internet enabling the older devices by creating products that have a serial port on one end and an Ethernet port on the other end, which can accept the data from the device and send the data over the internet. This is advantageous because it eliminates the need to do costly replacements for the device.

Embedded systems today can be connected to computer networks (for example, the internet) and to legacy devices. These embedded systems allow connectivity with various equipment, legacy as well as state of the art. For example, an embedded system allows network/internet connectivity to vending machines, refrigerators, utility meters, HVAC systems, and home entertainment systems.

Another problem is the ever-growing number of network enabled devices that have inadequate monitoring and control capabilities. These problems are pervasive, involving all manner of equipment from fax machines, printers, copiers and other office equipment, to specialized devices found in manufacturing plants, home appliances, hand-held electronics such as cameras, audio/video players and medical devices that have network capability but are not part of an integrated network. This problem is particularly acute for the administrators, who often find themselves spending a great deal of money and time bridging heterogeneous management systems. Most of these devices do not contain state information and are even more difficult to manage. A more homogeneous management environment can save time and money, but numerous vendors have many valid business and technical reasons for avoiding homogeneous management systems.

Device management functionality comes in many different forms depending on the administrator's needs and the capabilities of the target device. Common management functions include monitoring the device's critical information, taking an inventory of the device's sub-systems, logging interesting events that take place, sending alerts to an administrator, recovering the device if the power fails, ensuring the data is secure, asset tracking, or reporting information to an administrator. Administrators also employ more advanced management functions including scripting or programming, aggregating device data from multiple devices, diagnostics, taking action based on the device data content, trending device data, reporting information in a final format including a spreadsheet or graph, or translating from one management format to another. A major area of management functionality includes securing the device through providing confidentiality of data, data integrity, administrator authentication, device authentication, risk mitigation, countermeasures, or protection against hostile environments and threats.

As the devices may be legacy devices or too small to incorporate functionality other than sending raw data, the raw data sent may not be able to be analyzed by sophisticated data management and control systems. Therefore, there is a need to provide a means to alter the raw data into a form that may be managed and controlled by those systems.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an embodiment of a broker system 100.

FIG. 2 illustrates an embodiment of a message broker process 200.

FIG. 3 illustrates a message broker process 300.

FIG. 4 illustrates an embodiment of a data transformation process 400.

FIG. 5 illustrates an embodiment of a rules implementation system 500.

FIG. 6 illustrates an embodiment of a rules implementation system 600.

FIG. 7 illustrates an embodiment of an event management system 700.

FIG. 8 illustrates an embodiment of an action generation system 800.

FIG. 9 illustrates an embodiment of a system 900.

FIG. 10 is an example block diagram of a central control system 1000 that may incorporate embodiments of the present invention.

FIG. 11 illustrates an embodiment of an edge device 1100 to implement components and process steps of the system described herein.

### DETAILED DESCRIPTION

“Broker data receipt detector” herein refers to a device that may determine multiple states of another device, such as whether data has been received by the other device, and send a signal in response. An example software or firmware broker data receipt detector is: if (detectl.value=/=detect2.value) output.value=signal(transform, enrich); else null; Other examples of a broker data receipt detector will be readily apparent to those of skill in the art, without undo experimentation.

“Broker function transmitter” herein refers to a device that determines whether transformation and enrichment functions have been selected and sends those functions to a broker. If output.value=(transform.function, enrich.function) send output.value; else if output.value=(transform, 0) execute select.enrich; else if output.value=(0, enrich) execute select.transform; else execute select.transform, select.enrich. Other examples of a broker function transmitter will be readily apparent to those of skill in the art, without undo experimentation.

“Data enrichment handler” herein refers to logic to “wrap” e.g. decorate/enrich data.

“Enrichment function” herein refers to an operator to enrich data based on contextual parameter and add the additional data to the data. An example software or firmware transformation function is: if input={“sourceId”:String; “observation”:{“field1”:String, “field2”:int, “field3”:Date, “field4”:{ }, “field5”:List} } output={“data”:“sourceId”: String; “observation”:{“field1”:String, “field2”:int, “field3”:Date, “field4”:{ }, “field5”: List} } “context”:{“timestamp”:Date} }; Other examples of an enrichment function will be readily apparent to those of skill in the art, without undo experimentation.

“Transformation function” herein refers to an operator to transform data based on data type (e.g., sourcelD) and add the additional data to the data. An example software or firmware transformation function is: if input={“sourceId”:String; “observation”:{“key1”:“value1”, “key2”:“value2”, “keyn”:“valuen”}} output={“sourceId”:String; “observation”:{“field1”: String, “field2”:int, “field3”:Date, “field4”:{ }, “field5”:List}}; Other examples of a transformation function will be readily apparent to those of skill in the art, without undo experimentation.

References to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

“Circuitry” herein refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Context parameters” herein refers context surrounding the collected data to enrich the data, the device it came from, location, etc.

“Domain entity schema” herein refers to logical representation/definition of the structure of the device and/or data for example, the schema of an engine contains valves, a camshaft, etc.

“Edge devices” herein refers to any device which may originate data, i.e. a data source.

“Firmware” herein refers to software logic embodied as processor-executable instructions stored in read-only memories or media.

“Hardware” herein refers to logic embodied as analog or digital circuitry.

“Ingestion handler” herein refers to handles ingress of data pipeline into the broker.

“Logic” herein refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Message broker” herein refers to logic to handle ingress, coordination of various events.

“Programmable device” herein refers to an integrated circuit designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices. Configuration of the programmable device is generally specified using a computer code or data such as a hardware description language (HDL), such as for example Verilog, VHDL, or the like. A programmable device may include an array of programmable logic blocks and a hierarchy of reconfigurable interconnects that allow the programmable logic blocks to be coupled to each other according to the descriptions in the HDL code. Each of the programmable logic blocks may be configured to perform complex combinational functions, or merely simple logic gates, such as AND, and XOR logic blocks. In most FPGAs, logic blocks also include memory elements, which may be simple latches, flip-flops, hereinafter also referred to as “flops,” or more complex blocks of memory. Depending on the length of the interconnections between different logic blocks, signals may arrive at input terminals of the logic blocks at different times.

“Protocol adapter instructions” herein refers to instructions to provide to the protocol to extract the data from the payload e.g. data extraction instruction.

“Raw data” herein refers to unprocessed data collected from outside sources, for example, sensors.

“Raw observation” herein refers to transformed raw data.

“Software” herein refers to logic implemented as processor-executable instructions in a machine memory (e.g. read/write volatile or nonvolatile memory or media).

A system is disclosed to collect data from edge devices and to adapt the devices to improve their semi-autonomous operation. Conventional systems of this nature are complex and inflexible. The current system may be driven entirely remotely and/or locally and has a flexible architecture that can easily be modified to port onto different hardware platforms and operating systems, use available network connectivity on the target device, and use a protocol that is best utilized by the back end system.

“Transformed observation” herein refers to wrapped raw data.

“Transformation function” herein refers to individual functions to perform an individual transformation.

“Transformation handler” herein refers to logic to perform transformations, for example, taking a moving average.

“Wrapping the raw data” herein refers to decorating data with context parameters.

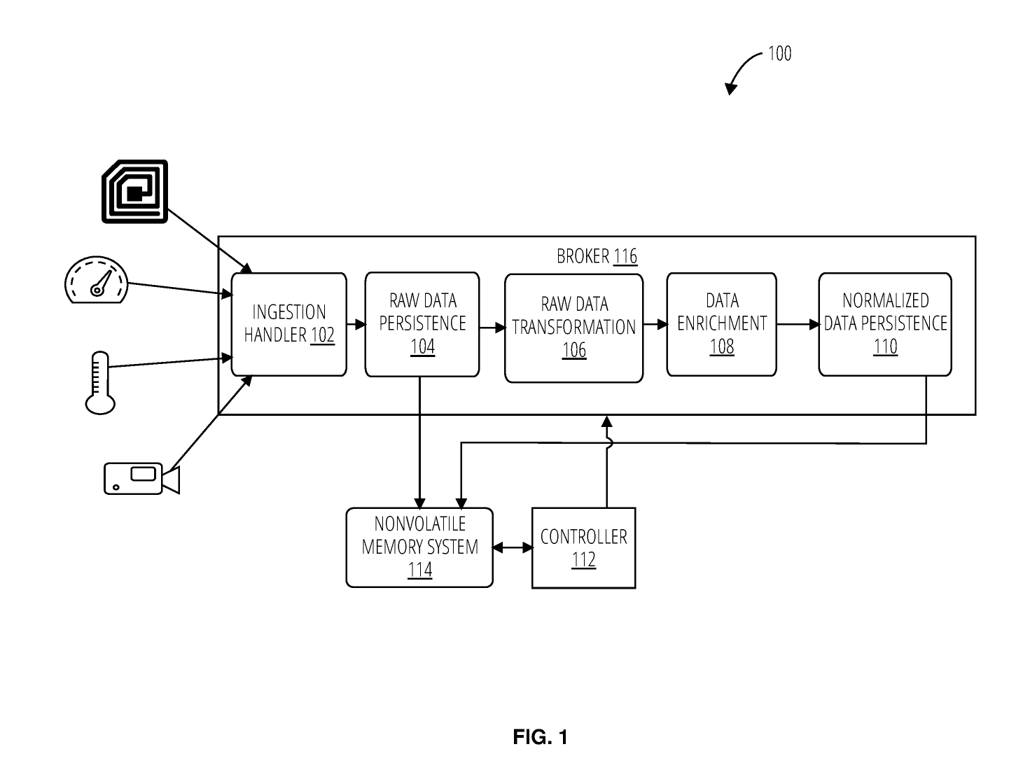

Referring to FIG. 1, a broker system 100 comprises a broker 116, a controller 112, and a nonvolatile memory system 114. The broker 116 further comprises an ingestion handler 102, raw data persistence 104, a raw data transformation 106, a data enrichment 108, and a normalized data persistence 110.

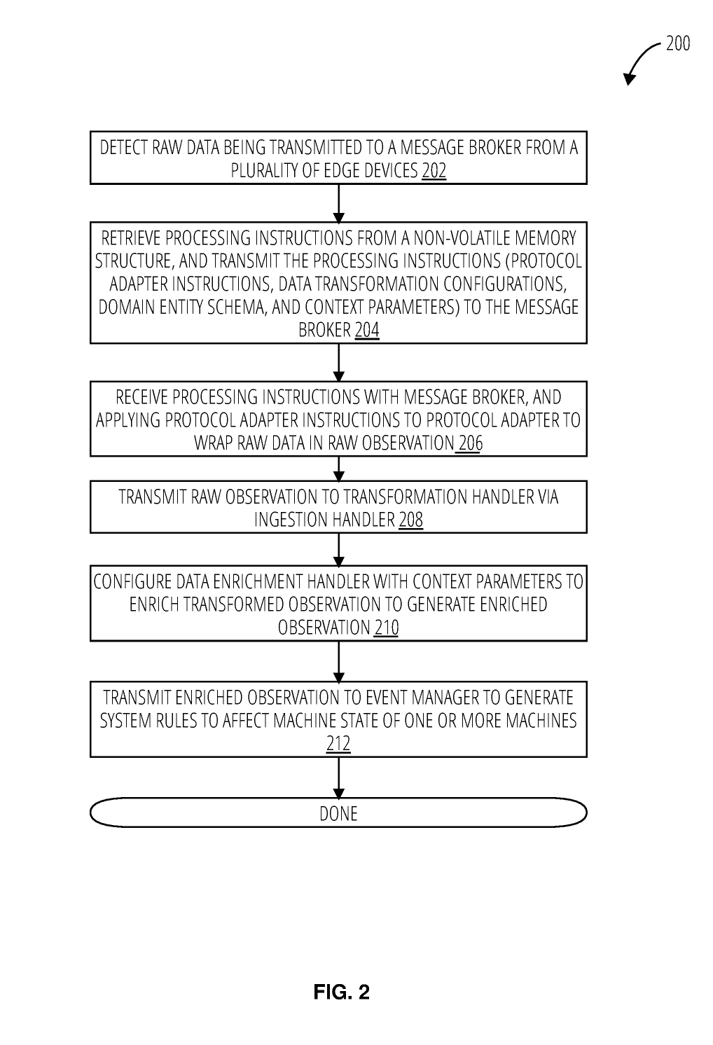

The ingestion handler 102 receives data from edge devices. The data may be edge device states transmitted by messages. The raw data persistence 104 may be stored in the nonvolatile memory system 114 and/or transformed and enriched by the raw data transformation 106 and the data enrichment 108, respectively, into the normalized data persistence 110. The normalized data persistence 110 may be stored in the nonvolatile memory system 114. The controller 112 may provide instructions to the broker 116 to manage each of the ingestion handler 102, the raw data persistence 104, the raw data transformation 106, the data enrichment 108, and the normalized data persistence 110. The nonvolatile memory system 114 may store the instructions for the controller 112 to interact with the broker 116. In some embodiments, the controller 112 may send a request to the nonvolatile memory system 114 for instructions. The broker system 100 may be operated in accordance with the process shown in FIG. 2.

Referring to FIG. 2, the message broker process 200 detects (with a controller) raw data being transmitted to a message broker from a plurality of edge devices (block 202).

The message broker process 200 retrieves (with the controller) processing instructions from a non-volatile memory structure, and transmits the processing instructions (protocol adapter instructions, data transformation configurations, a domain entity schema, context parameters) to the message broker (block 204).

The message broker process 200 receives the processing instructions with the message broker, and applies the protocol adapter instructions to a protocol adapter to wrap the raw data in a raw observation (block 206).

The message broker process 200 transmits the raw observation to a transformation handler via an ingestion handler, the message broker configures the transformation handler with the data transformation configurations and the domain entity schema to transform the raw observation into a transformed observation (block 208).

The message broker process 200 configures a data enrichment handler with the context parameters to enrich the transformed observation to generate an enriched observation (block 210).

The message broker process 200 transmits the enriched observation to an event manager to generate system rules to affect a machine state of one or more machines (block 212).

A method may include detecting raw data; utilizing a controller to retrieve processing instructions from a non-volatile memory structure, and the controller transmitting the processing instructions to the message broker. The message broker receives the processing instructions, applies the protocol adapter instructions to a protocol adapter to wrap the raw data in a raw observation, and transmitts the raw observation to a transformation handler via an ingestion handler. The message broker configures the transformation handler with the data transformation configurations and the domain entity schema to transform the raw observation into a transformed observation. A data enrichment handler is configured with the context parameters to enrich the transformed observation to generate an enriched observation and/or transmit the enriched observation to an event manager to generate system rules to affect a machine state of one or more machines.

A raw observation may be transmitted to a message broker from a group of edge devices, with a controller. The processing instructions may include protocol adapter instructions, data transformation configurations, a domain entity schema, and/or context parameters. The data transformation configurations specify the application of at least one data transformation function. The event manager generating the system rules may further include receiving enriched data, determining rules based on the enriched data, identifying a pattern in the enriched data utilizing the rules, determining the pattern is an event, and/or performing an action based on the event. The action may be to send a rule update signal. The rules update signal may include instructions to re-determine the rules. The action may be generating a transformation function and an enrichment function. The action may be sending a device control signal to a device. The device control signal may include instructions to alter the machine state of the edge device.

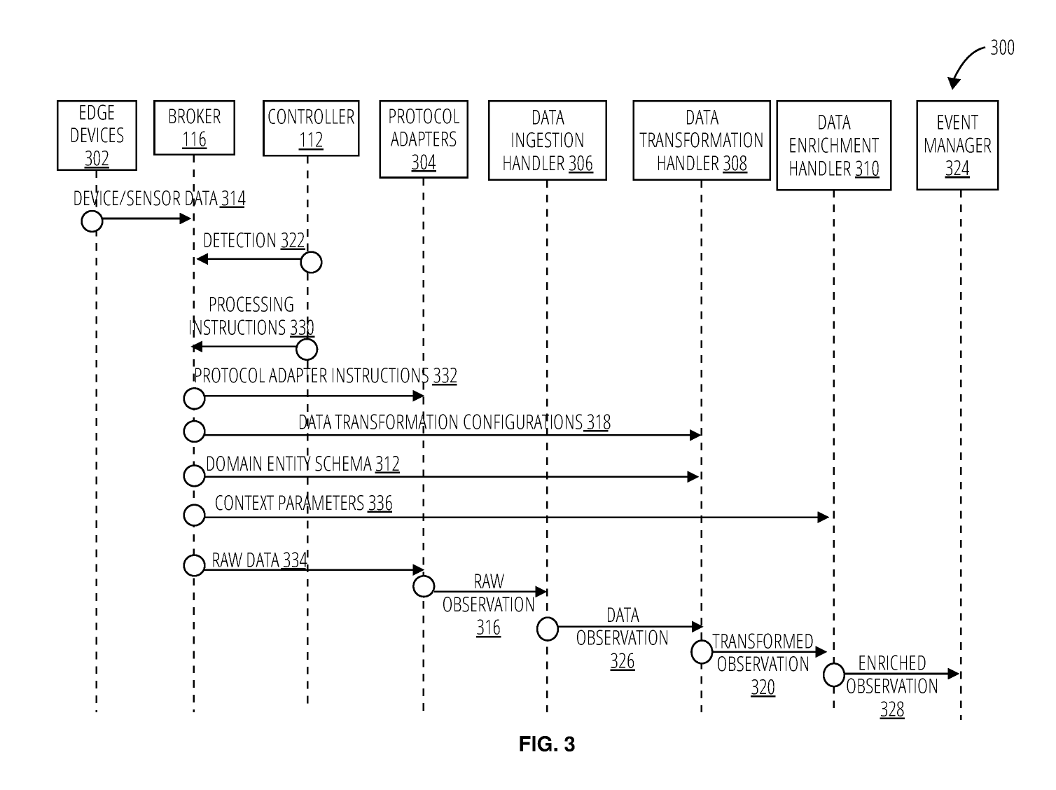

Referencing FIG. 3, the message broker process 300 comprises a controller 112, a broker 116, edge devices 302, protocol adapters 304, a data ingestion handler 306, a data transformation handler 308, a data enrichment handler 310, a domain entity schema 312, device/sensor data 314, a raw observation 316, data transformation configurations 318, a transformed observation 320, a detection 322, an event manager 324, a data observation 326, an enriched observation 328, processing instructions 330, protocol adapter instructions 332, raw data 334, and context parameters 336.

The broker 116 receives the device/sensor data 314 from the edge devices 302, and the controller 112 performs detection 322 to detect the transmission of the device/sensor data 314. The controller 112 sends processing instructions 330 to the broker 116, the processing instructions 330 comprising the protocol adapter instructions 332, the data transformation configurations 318, the domain entity schema 312 and the context parameters 336. The broker 116 sends the protocol adapter instructions 332 to the protocol adapters 304, the domain entity schema 312 and the context parameters 336 to the data transformation handler 308, and the context parameters 336 to the data enrichment handler 310. The broker 116 transmits the raw data 334 to the protocol adapters 304. The protocol adapters 304 transform the raw data 334 into the raw observation 316 and transmits the raw observation 316 to the data ingestion handler 306. The data ingestion handler 306 transforms the raw observation 316 into the data observation 326 and transmits the data observation 326 to the data enrichment handler 310. The enriched observation 328 transforms the transformed observation 320 into the enriched observation 328 and transmits the enriched observation 328 to the event manager 324.

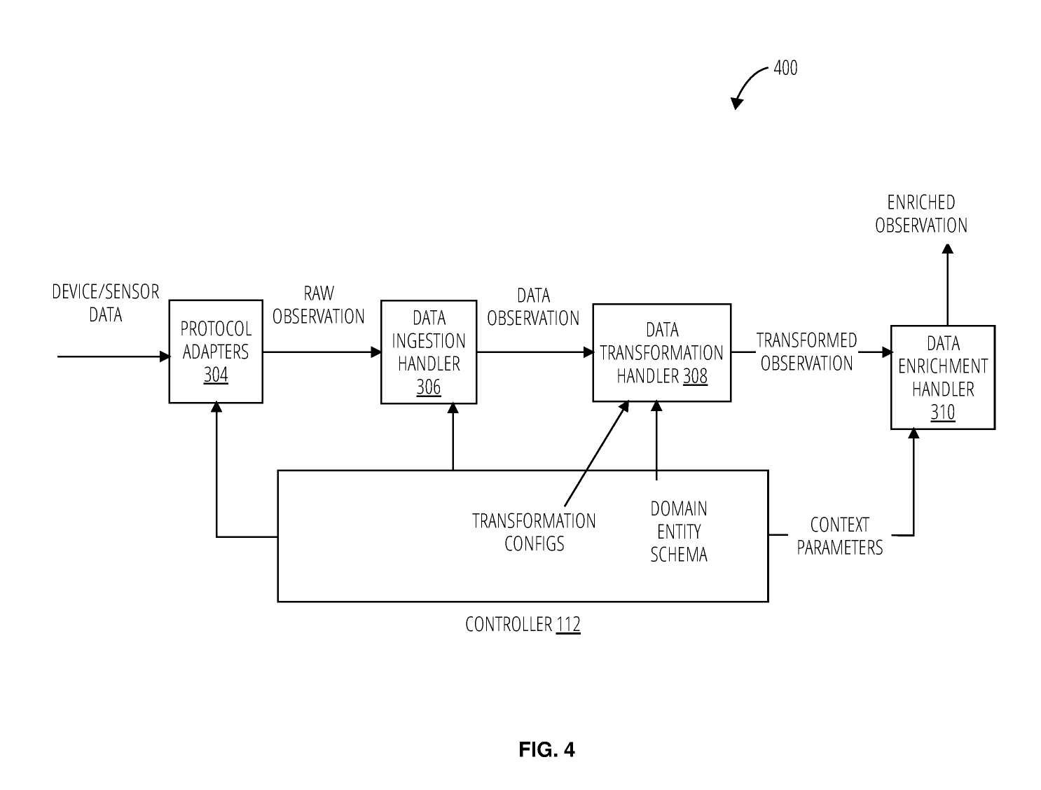

Referring to FIG. 4, a data transformation process 400 comprises a controller 112, protocol adapters 304, a data ingestion handler 306, a data transformation handler 308, and a data enrichment handler 310.

The controller 112 may provide instructions to the protocol adapters 304, the data ingestion handler 306, the data transformation handler 308, and the data enrichment handler 310. The instructions, which may include transformation configs, a domain entity schema, and context parameters, provide information to perform the action described below. The controller 112 may be operated in accordance with FIG. 2.

The protocol adapters 304 receives device/sensor data and sends raw observation to the data ingestion handler 306. The protocol adapters 304 may have different adapters for different protocols. The protocol adapters 304 check the incoming messages (e.g., device/sensor data) to determine whether the message is sent from a registered source. The protocol adapters 304 fetch the ‘sourceId’ for the incoming messages, wraps data into the raw observation, and may send the raw observation to a data pipeline.

The raw observation may be in the following schema:

```
{
    “sourceId” : String,
    “observation” : byte [ ]
}
```

The data ingestion handler 306 receives the raw observation from the protocol adapters 304 and sends a data observation to the data transformation handler 308. The data ingestion handler 306 consumes messages from the pipeline, deserializes incoming messages against the raw observation schema, and debundles the observation bytes against a <K,V> map or a list of <K,V> maps. The data ingestion handler 306 then decorates the data into the data observation and sends to the data transformation handler 308.

The data observation may be in the following schema:

```
{
    “sourceId” : String
    “observation” :
    {
        “key1” : “value1”,
        “key2” : “value2”,
        “keyn” : “valuen”
    }
}
```

The data transformation handler 308 receives the data observation from the data ingestion handler 306 and sends a transformed observation to the data enrichment handler 310. The data transformation handler 308 fetches transformation configs based on the ‘sourceId’, applies the transformations based on the transformation configs, fetches the domain entity schema using the ‘sourceId” and transforms each observation map against the entity schema. The data transformation handler 308 then decorates the data into the transformed observation and sends to the data enrichment handler 310.

The transformed observation may be in the following schema:

```
{
    “sourceId” : String
    “observation” :
    {
        “field1” : String,
        “field2” : int,
        “field3” : Date,
        “field4” :
              {
              },
        “field5” : List
    }
}
```

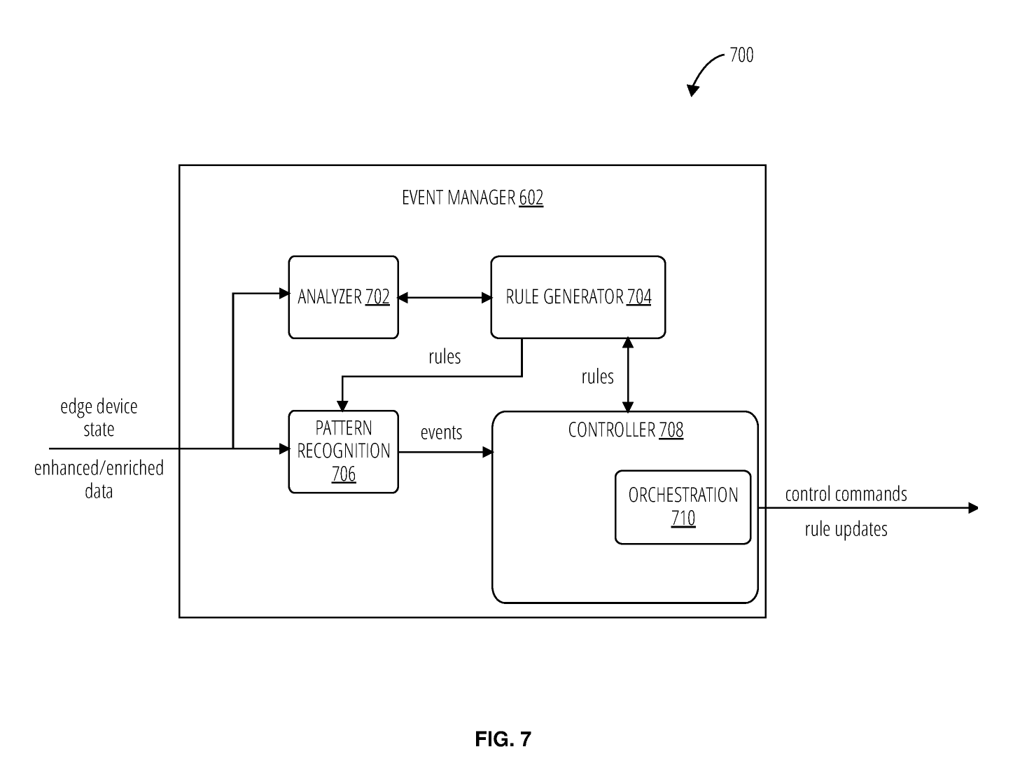

The data enrichment handler 310 receives the transformed observation and produces an enriched observation. The data enrichment handler 310 fetches context parameters for the observation and generates context information for the transformed observation. The data enrichment handler 310 decorates the data into the enriched observation. The enriched observation (i.e., enhanced/enriched data) may then be received by the event management system 700 as depicted in FIG. 7.

The enriched observation may be in the following schema:

```
{
    “data” :
        {
            “sourceId” : String
            “observation” :
                {
                    “field1” : String,
                    “field2” : int,
                    “field3” : Date,
                    “field4” :
                        {
                        },
                    “field5” : List
                {
        {
        “context” :
            {
                “timestamp” : Date
            {
{
```

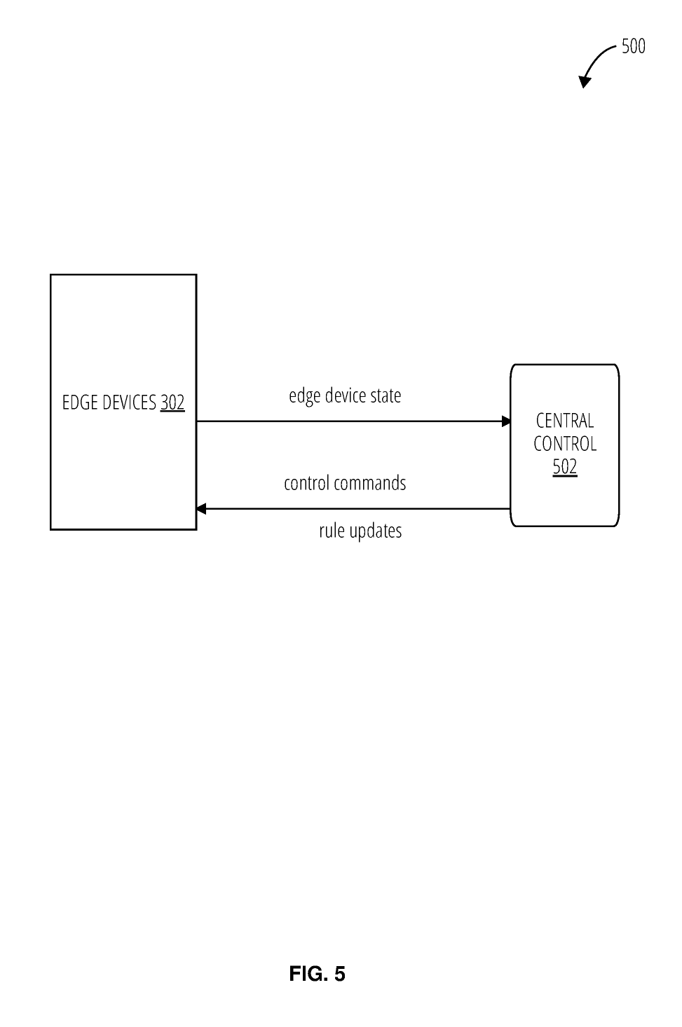

Referring to FIG. 5, a rules implementation system 500 comprises a central control 502 and edge devices 302.

The central control 502 communicates control commands and rule updates to the edge devices 302. The central control 502 may communicate directly or via a network.

The edge devices 302 communicate an edge device state to the central control 502. The edge devices 302 may communicate with the central control 502 directly or via a network (e.g., routers, hubs, servers, gateways, network bridges, modems, wireless access points, networking cables, line drivers, switches, and repeaters, and also include hybrid network devices such as multilayer switches, protocol converters, bridge routers, proxy servers, firewalls, network address translators, multiplexers, network interface controllers, wireless network interface controllers, ISDN terminal adapters, WAN, LAN, WWW, etc.).

The edge device state, control commands, and the rule updates may be communicated using various network protocols including MQTT, a lightweight publish/subscribe messaging transport that may utilize a message broker to route messages; MQTT-SN, a connectionless publish/subscribe messaging transport designed for low bandwidth unreliable communication environments, which may be easily integrated with MQTT using a MQTT-SN to MQTT Bridge; AMQP 1.0, a full publish/subscribe messaging protocol that provides topics, queues, full message routing and a well-defined security model; HTTP, the standard client/server protocol of the World Wide Web; and CoAP, a RESTful client/server protocol for resource constrained devices and networks, which may be integrated with HTTP using a CoAP to HTTP Bridge.

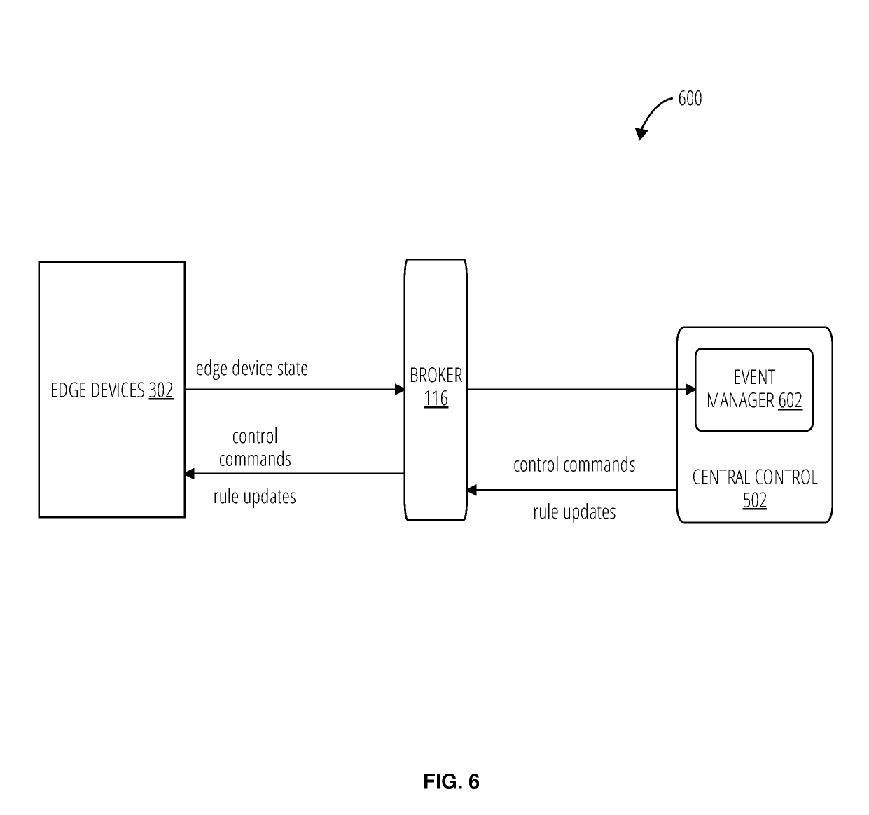

Referring to FIG. 6, a rules implementation system 600 comprises a central control 502, edge devices 302, and a broker 116. The central control 502 further comprises an event manager 602.

The central control 502 sends control commands and rule updates to the broker 116 and receives signals from the broker 116. The edge devices 302 communicate the edge device state to the broker 116 and receive control commands and rule updates from the broker 116.

The broker 116 receives the edge device state from the edge devices 302 and the control commands and rule updates from the central control 502. The broker 116 sends the control commands and the rule updates to the edge devices 302 and signals to the central control 502. A broker 116 may be utilized to perform functions that the edge devices 302 lack (e.g., some edge devices 302 may lack the capability to encrypt information). In some embodiments, the broker 116 may be located on the edge devices 302. The broker 116 may also be located on the same local area network as the edge devices 302. Each of the edge devices 302 may have a different broker 116. The edge devices 302 located on the same local area network may utilize the same broker 116. The broker 116 is further described in FIG. 1. The broker 116 may be operated in accordance with FIG. 2.

The event manager 604 is further described in FIG. 7.

Referring to FIG. 7, an event management system 700 comprises an event manager 602, which further comprises an analyzer 702, a rule generator 704, a pattern recognition 706, and a controller 708. The controller 708 may comprise an orchestration 710. The event manager 602 receives an edge device state and enhanced/enriched data and outputs rule updates and control commands.

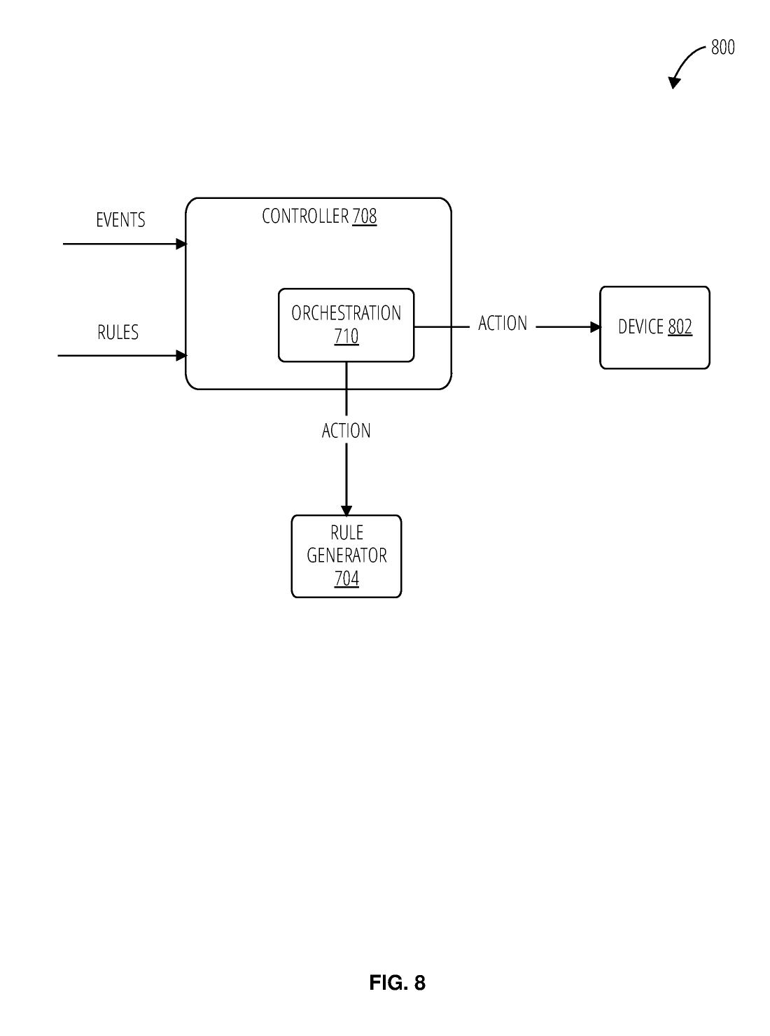

The analyzer 702 receives the edge device state and sends an analyzed edge device state to the rule generator 704. The rule generator 704 receives an analyzed edge device state from the analyzer 702 and rules from the controller 708. The rule generator 704 generates rules and sends the rules to the pattern recognition 706 and the controller 708. The pattern recognition 706 receives the edge device state and the rules from the rule generator 704 and sends events to the controller 708. The controller 708 receives the rules from the rule generator 704 and the events from the pattern recognition 706. The controller 708 sends the rules to the rule generator 704 and sends rule updates and control commands. The orchestration 710 is described in FIG. 8.

Referring to FIG. 8, the action generation system 800 comprises a rule generator 704, a controller 708, which comprises an orchestration 710, and a device 802.

The controller 708 may receive events and rules as depicted in FIG. 7. The controller 708 sends the events and rules to the orchestration 710, which then determines an action. Generated actions may be sent to the rule generator 704 and the device 802. The action may be sent to the device 802 via a broker. The device 802 may include edge devices, memory storage device analytical systems, etc. The actions may include rule updates, instruction to create a new rule, control commands, etc.

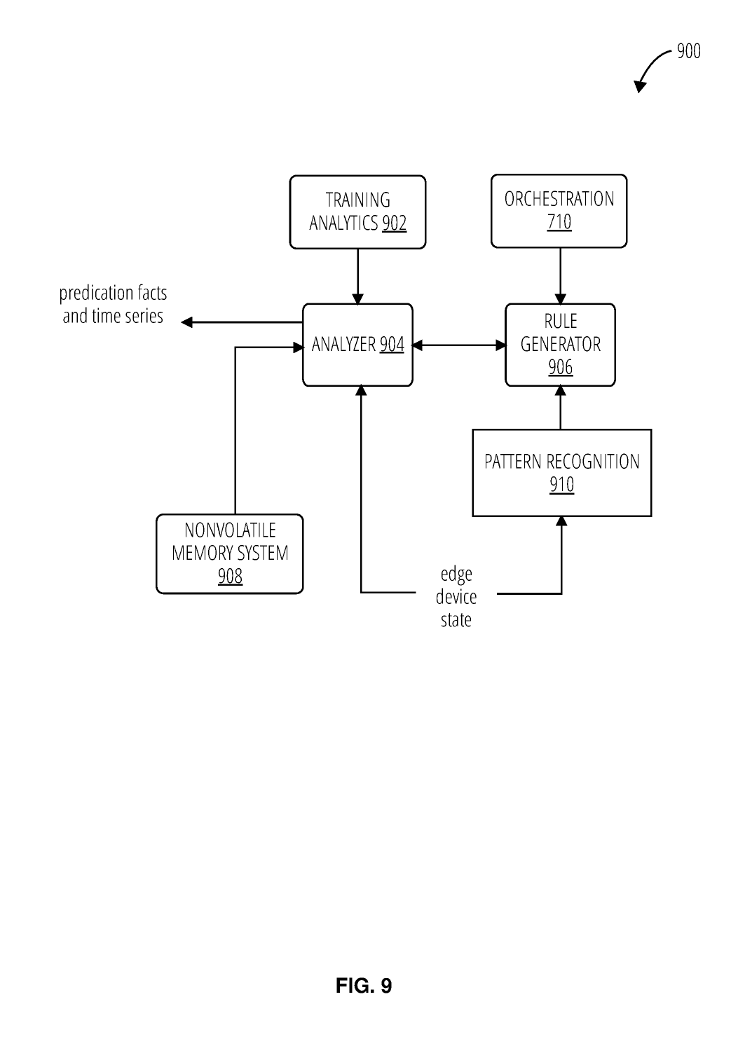

Referring to FIG. 9, the system 900 comprises an orchestration 710, training analytics 902, an analyzer 904, a rule generator 906, a nonvolatile memory system 908, and a pattern recognition 910.

The analyzer 904 receives an edge device state, rules from the rule generator 906, data from the training analytics 902, and data from the nonvolatile memory system 908. The analyzer 904 sends analyzed rules to the rule generator 906 and outputs predication facts and time series. The rule generator 906 receives an event from the pattern recognition 910 based on the edge device state received by the pattern recognition 910, analyzed rules from the analyzer 904, and orchestrated data from the orchestration 710, and sends generated rules to the analyzer 904. The training analytics 902 sends data to the analyzer 904. The orchestration 710 sends the orchestrated data to the rule generator 906. The orchestrated data may comprise formatting data for the rules generated by the rule generator 906. The nonvolatile memory system 908 provides data to the analyzer 904.

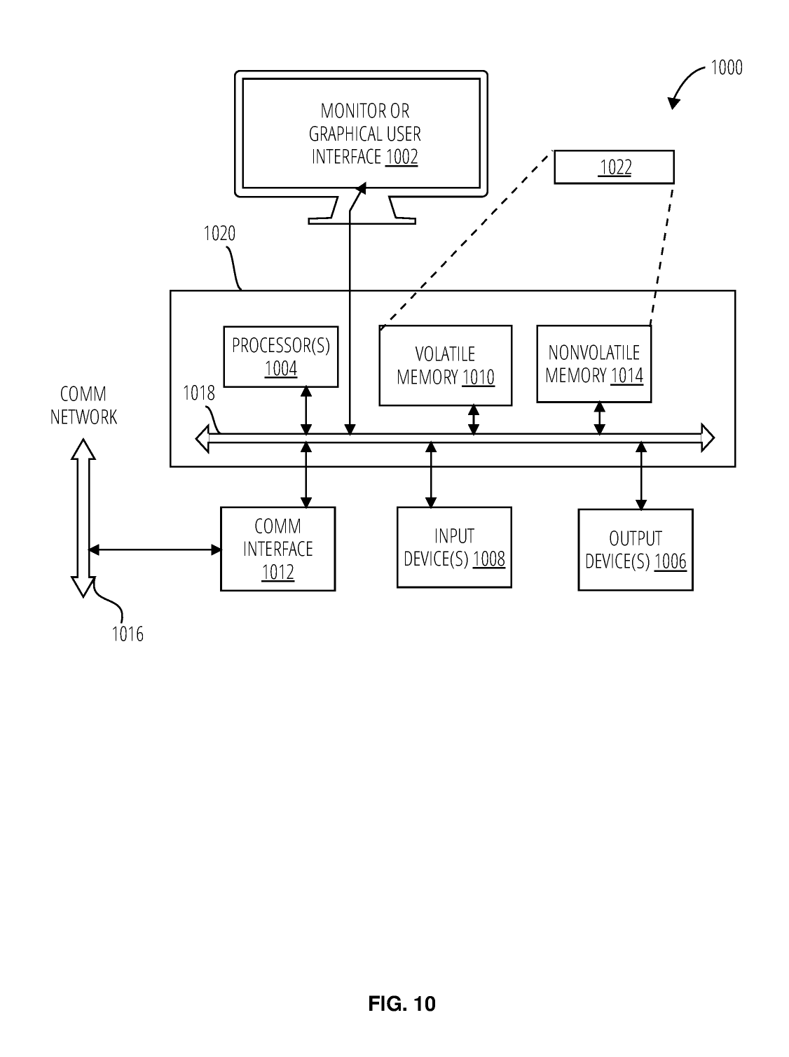

FIG. 10 is an example block diagram of a central control system 1000 that may incorporate embodiments of the present invention. FIG. 10 is merely illustrative of a machine system to carry out aspects of the technical processes described herein, and does not limit the scope of the claims. One of ordinary skill in the art would recognize other variations, modifications, and alternatives. In one embodiment, the central control system 1000 typically includes a monitor or graphical user interface 1002, a data processing system 1020, a communication network interface 1012, input device(s) 1008, output device(s) 1006, and the like.

As depicted in FIG. 10, the data processing system 1020 may include one or more processor(s) 1004 that communicate with a number of peripheral devices via a bus subsystem 1018. These peripheral devices may include input device(s) 1008, output device(s) 1006, communication network interface 1012, and a storage subsystem, such as a volatile memory 1010 and a nonvolatile memory 1014.

The volatile memory 1010 and/or the nonvolatile memory 1014 may store computer-executable instructions and thus forming logic 1022 that when applied to and executed by the processor(s) 1004 implement embodiments of the processes disclosed herein.

The input device(s) 1008 include devices and mechanisms for inputting information to the data processing system 1020. These may include a keyboard, a keypad, a touch screen incorporated into the monitor or graphical user interface 1002, audio input devices such as voice recognition systems, microphones, and other types of input devices. In various embodiments, the input device(s) 1008 may be embodied as a computer mouse, a trackball, a track pad, a joystick, wireless remote, drawing tablet, voice command system, eye tracking system, and the like. The input device(s) 1008 typically allow a user to select objects, icons, control areas, text and the like that appear on the monitor or graphical user interface 1002 via a command such as a click of a button or the like.

The output device(s) 1006 include devices and mechanisms for outputting information from the data processing system 1020. These may include speakers, printers, infrared LEDs, and so on as well understood in the art.

The communication network interface 1012 provides an interface to communication networks (e.g., communication network 1016) and devices external to the data processing system 1020. The communication network interface 1012 may serve as an interface for receiving data from and transmitting data to other systems. Embodiments of the communication network interface 1012 may include an Ethernet interface, a modem (telephone, satellite, cable, ISDN), (asynchronous) digital subscriber line (DSL), FireWire, USB, a wireless communication interface such as Bluetooth or WiFi, a near field communication wireless interface, a cellular interface, and the like.

The communication network interface 1012 may be coupled to the communication network 1016 via an antenna, a cable, or the like. In some embodiments, the communication network interface 1012 may be physically integrated on a circuit board of the data processing system 1020, or in some cases may be implemented in software or firmware, such as “soft modems”, or the like.

The central control system 1000 may include logic that enables communications over a network using protocols such as HTTP, TCP/IP, RTP/RTSP, IPX, UDP and the like.

The volatile memory 1010 and the nonvolatile memory 1014 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1010 and the nonvolatile memory 1014 may be configured to store the basic programming and data constructs that provide the functionality of the disclosed processes and other embodiments thereof that fall within the scope of the present invention.

Logic 1022 that implements embodiments of the present invention may be stored in the volatile memory 1010 and/or the nonvolatile memory 1014. Said software may be read from the volatile memory 1010 and/or nonvolatile memory 1014 and executed by the processor(s) 1004. The volatile memory 1010 and the nonvolatile memory 1014 may also provide a repository for storing data used by the software.

The volatile memory 1010 and the nonvolatile memory 1014 may include a number of memories including a main random access memory (RAM) for storage of instructions and data during program execution and a read only memory (ROM) in which read-only non-transitory instructions are stored. The volatile memory 1010 and the nonvolatile memory 1014 may include a file storage subsystem providing persistent (non-volatile) storage for program and data files. The volatile memory 1010 and the nonvolatile memory 1014 may include removable storage systems, such as removable flash memory.

The bus subsystem 1018 provides a mechanism for enabling the various components and subsystems of data processing system 1020 communicate with each other as intended. Although the communication network interface 1012 is depicted schematically as a single bus, some embodiments of the bus subsystem 1018 may utilize multiple distinct busses.

It will be readily apparent to one of ordinary skill in the art that the central control system 1000 may be a device such as a smartphone, a desktop computer, a laptop computer, a rack-mounted computer system, a computer server, or a tablet computer device. As commonly known in the art, the central control system 1000 may be implemented as a collection of multiple networked computing devices. Further, the central control system 1000 will typically include operating system logic (not illustrated) the types and nature of which are well known in the art.

Those having skill in the art will appreciate that there are various logic implementations by which processes and/or systems described herein can be effected (e.g., hardware, software, or firmware), and that the preferred vehicle will vary with the context in which the processes are deployed. If an implementer determines that speed and accuracy are paramount, the implementer may opt for a hardware or firmware implementation; alternatively, if flexibility is paramount, the implementer may opt for a solely software implementation; or, yet again alternatively, the implementer may opt for some combination of hardware, software, or firmware. Hence, there are numerous possible implementations by which the processes described herein may be effected, none of which is inherently superior to the other in that any vehicle to be utilized is a choice dependent upon the context in which the implementation will be deployed and the specific concerns (e.g., speed, flexibility, or predictability) of the implementer, any of which may vary. Those skilled in the art will recognize that optical aspects of implementations may involve optically-oriented hardware, software, and or firmware.

Those skilled in the art will appreciate that logic may be distributed throughout one or more devices, and/or may be comprised of combinations memory, media, processing circuits and controllers, other circuits, and so on. Therefore, in the interest of clarity and correctness logic may not always be distinctly illustrated in drawings of devices and systems, although it is inherently present therein. The techniques and procedures described herein may be implemented via logic distributed in one or more computing devices. The particular distribution and choice of logic will vary according to implementation.

The foregoing detailed description has set forth various embodiments of the devices or processes via the use of block diagrams, flowcharts, or examples. Insofar as such block diagrams, flowcharts, or examples contain one or more functions or operations, it will be understood as notorious by those within the art that each function or operation within such block diagrams, flowcharts, or examples can be implemented, individually or collectively, by a wide range of hardware, software, firmware, or virtually any combination thereof. Portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more processing devices (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, flash drives, SD cards, solid state fixed or removable storage, and computer memory.

In a general sense, those skilled in the art will recognize that the various aspects described herein which can be implemented, individually or collectively, by a wide range of hardware, software, firmware, or any combination thereof can be viewed as being composed of various types of circuitry.

Those skilled in the art will recognize that it is common within the art to describe devices or processes in the fashion set forth herein, and thereafter use standard engineering practices to integrate such described devices or processes into larger systems. At least a portion of the devices or processes described herein can be integrated into a network processing system via a reasonable amount of experimentation. Various embodiments are described herein and presented by way of example and not limitation.

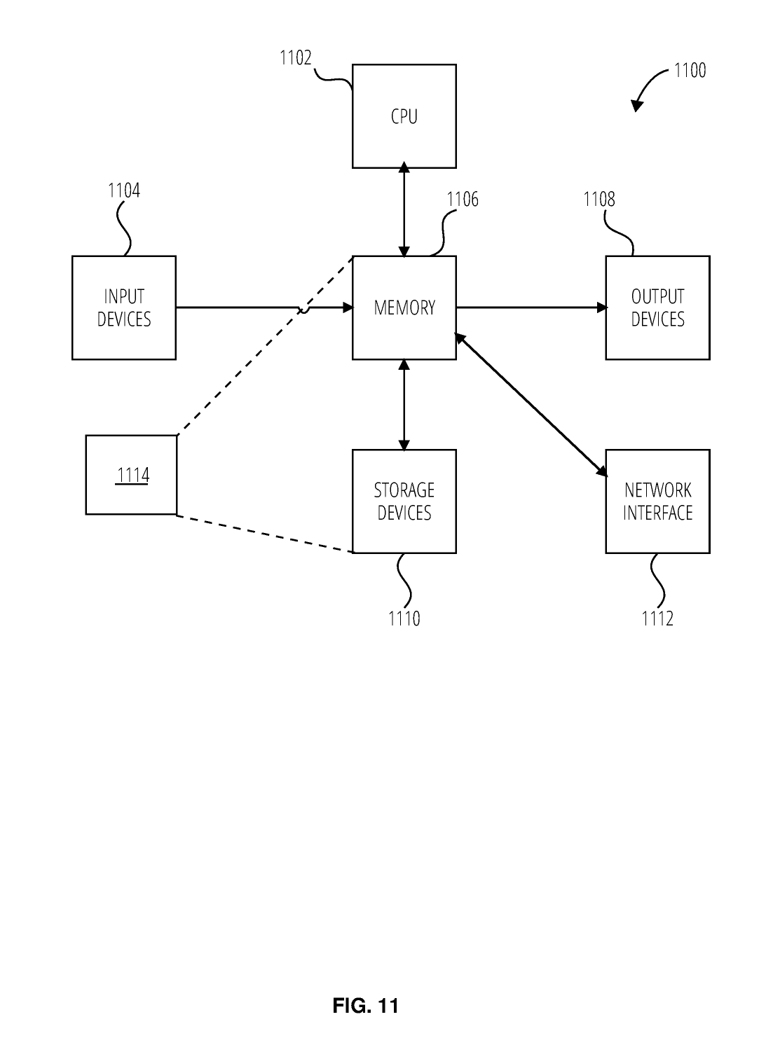

FIG. 11 illustrates an embodiment of an edge device 1100 to implement components and process steps of the system described herein.

Input devices 1104 comprise transducers that convert physical phenomenon into machine internal signals, typically electrical, optical or magnetic signals. Signals may also be wireless in the form of electromagnetic radiation in the radio frequency (RF) range but also potentially in the infrared or optical range. Examples of input devices 1104 are keyboards which respond to touch or physical pressure from an object or proximity of an object to a surface, mice which respond to motion through space or across a plane, microphones which convert vibrations in the medium (typically air) into device signals, scanners which convert optical patterns on two or three dimensional objects into device signals. The signals from the input devices 1104 are provided via various machine signal conductors (e.g., busses or network interfaces) and circuits to memory 1106.

The memory 1106 is typically what is known as a first or second level memory device, providing for storage (via configuration of matter or states of matter) of signals received from the input devices 1104, instructions and information for controlling operation of the CPU 1102, and signals from storage devices 1110.

The memory 1106 and/or the storage devices 1110 may store computer-executable instructions and thus forming logic 1114 that when applied to and executed by the CPU 1102 implement embodiments of the processes disclosed herein.

Information stored in the memory 1106 is typically directly accessible to the CPU 1102 of the device. Signals input to the device cause the reconfiguration of the internal material/energy state of the memory 1106, creating in essence a new machine configuration, influencing the behavior of the edge device 1100 by affecting the behavior of the CPU 1102 with control signals (instructions) and data provided in conjunction with the control signals.

Second or third level storage devices 1110 may provide a slower but higher capacity machine memory capability. Examples of storage devices 1110 are hard disks, optical disks, large capacity flash memories or other non-volatile memory technologies, and magnetic memories.

The CPU 1102 may cause the configuration of the memory 1106 to be altered by signals in storage devices 1110. In other words, the CPU 1102 may cause data and instructions to be read from storage devices 1110 in the memory 1106 from which may then influence the operations of CPU 1102 as instructions and data signals, and from which it may also be provided to the output devices 1108. The CPU 1102 may alter the content of the memory 1106 by signaling to a machine interface of memory 1106 to alter the internal configuration, and then converted signals to the storage devices 1110 to alter its material internal configuration. In other words, data and instructions may be backed up from memory 1106, which is often volatile, to storage devices 1110, which are often non-volatile.

Output devices 1108 are transducers which convert signals received from the memory 1106 into physical phenomenon such as vibrations in the air, or patterns of light on a machine display, or vibrations (i.e., haptic devices) or patterns of ink or other materials (i.e., printers and 3-D printers).

The network interface 1112 receives signals from the memory 1106 and converts them into electrical, optical, or wireless signals to other machines, typically via a machine network. The network interface 1112 also receives signals from the machine network and converts them into electrical, optical, or wireless signals to the memory 1106.

What is claimed is:

1. A method comprising:
detecting raw data being transmitted to a message broker from a plurality of edge devices, with a controller;
retrieving, with the controller, processing instructions from a non-volatile memory structure, and the controller transmitting the processing instructions to the message broker, the processing instructions comprising:
protocol adapter instructions;
data transformation configurations;
a domain entity schema; and
context parameters;
receiving the processing instructions with the message broker, and applying the protocol adapter instructions to a protocol adapter to wrap the raw data in a raw observation;
transmitting the raw observation to a transformation handler via an ingestion handler, the transformation handler configured by the message broker with the data transformation configurations and the domain entity schema to transform the raw observation into a transformed observation;
configuring a data enrichment handler with the context parameters to enrich the transformed observation to generate an enriched observation; and
transmitting the enriched observation to an event manager to generate system rules to affect a machine state of one or more machines.

2. The method of claim 1 wherein the data transformation configurations specify the application of at least one data transformation function.

3. The method of claim 1, wherein the event manager generating the system rules further comprises:
receiving enriched data;
determining rules based on the enriched data;
identifying a pattern in the enriched data utilizing the rules;
determining the pattern is an event; and
performing an action based on the event.

4. The method of claim 3 wherein the action is to send a rules update signal, the rules update signal comprising instructions to re-determine the rules.

5. The method of claim 3 wherein the action is to generate a transformation function and an enrichment function.

6. The method of claim 3, wherein the action is to send a device control signal to an edge device, the device control signal comprising instructions to alter the machine state of the edge device.

7. A computing apparatus, the computing apparatus comprising:
a processor; and
a memory storing instructions that, when executed by the processor, configure the apparatus to:
detect raw data being transmitted to a message broker from a plurality of edge devices, with a controller;
retrieve, with the controller, processing instructions from a non-volatile memory structure, and the controller transmitting the processing instructions to the message broker, the processing instructions comprising:
protocol adapter instructions;
data transformation configurations;
a domain entity schema; and
context parameters;
receive the processing instructions with the message broker, and applying the protocol adapter instructions to a protocol adapter to wrap the raw data in a raw observation;
transmit the raw observation to a transformation handler via an ingestion handler, the transformation handler configured by the message broker with the data transformation configurations and the domain entity schema to transform the raw observation into a transformed observation;
configure a data enrichment handler with the context parameters to enrich the transformed observation to generate an enriched observation; and
transmit the enriched observation to an event manager to generate system rules to affect a machine state of one or more machines.

8. The computing apparatus of claim 7 wherein the data transformation configurations specify the application of at least one data transformation function.

9. The computing apparatus of claim 7, wherein the event manager generating the system rules further comprises:
receiving enriched data;
determining rules based on the enriched data;
identifying a pattern in the enriched data utilizing the rules;
determining the pattern is an event; and
performing an action based on the event.

10. The computing apparatus of claim 9 wherein the action is to send a rules update signal, the rules update signal comprising instructions to re-determine the rules.

11. The computing apparatus of claim 9 wherein the action is to generate a transformation function and an enrichment function.

12. The computing apparatus of claim 9, wherein the action is to send a device control signal to a device, the device control signal comprising instructions to alter the machine state of the edge device.

13. The A system comprising:
a controller configured to detect raw data being transmitted to a message broker from a plurality of edge devices and to retrieve processing instructions from a non-volatile memory structure, and transmit the processing instructions to the message broker, the processing instructions comprising:
protocol adapter instructions;
data transformation configurations;
a domain entity schema; and
context parameters;
the message broker configured to receive the processing instructions and applying the protocol adapter instructions to a protocol adapter to wrap the raw data in a raw observation;
a transformation handler configured to transmit the raw observations to an ingestion handler, the transformation handler configured by the message broker with the data transformation configurations and the domain entity schema to a transformation function to transform the raw observation into a transformed observation;
configuring a data enrichment handler with the context parameters to enrich the transformed observation to generate an enriched observation and transmit the enriched observation to an event manager; and
the event manager configured to:
receive enriched data, determine rules based on the enriched data to identify a pattern in the enriched data utilizing the rules, determine the pattern is an event, and performing an action based on the event.
